(19) United States
(12) Patent Application Publication
(10) Pub. No.: US 2026/0296381 A1
(43) Pub. Date: Oct. 1, 2026

(54) SYSTEM AND METHOD FOR ALIGNING A PIPE WITH A WELL

(71) Applicant: Kent R. Madison, Echo, OR (US)

(72) Inventor: Kent R. Madison, Echo, OR (US)

(21) Appl. No.: 19/564,927

(22) Filed: Mar. 12, 2026

Related U.S. Application Data
(60) Provisional application No. 63/781,115, filed on Mar. 31, 2025.

(51) Int. Cl. B60S 9/12; E21B 19/00

(52) U.S. Cl. CPC B60S 9/12; E21B 19/00

(57) ABSTRACT

A system for aligning a pipe with a well includes a laser receiver and a laser transmitter, where one of the laser receiver and laser transmitter is positionable adjacent the well and the other of the laser receiver and laser transmitter is mounted to a first end portion of a mast extending from a vehicle and configured to lift the pipe. The laser transmitter is configured to emit a laser beam in a direction of the laser receiver. One or more actuators are coupled to the vehicle and are configured to receive a control signal from a controller to tilt the vehicle for pipe alignment. Also disclosed herein are systems for aligning a pipe with a well including more than one laser receiver each with a respective laser transmitter.

### CROSS REFERENCE TO RELATED APPLICATION

This application claims the benefit of U.S. Provisional Patent Application No. 63/781,115, filed Mar. 31, 2025, which is incorporated by reference herein in its entirety.

### FIELD

The present disclosure relates to a system and a method for aligning a pipe for insertion into a well.

### BACKGROUND

Pipes can be installed in wells to line the well borehole and, in some examples, facilitate transfer of a fluid, such as oil or water, to and from the surface. Known well configurations comprise pipe columns disposed within the well, where the pipe columns can be arranged to extend between an underground fluid reservoir, such as an aquifer, and the surface. The fluid can be conveyed through the pipe column from the underground reservoir to the surface where the fluid can be used or processed. In some examples, the fluid can be transferred from the underground reservoir to the surface. In some examples, the fluid can be transferred from the surface to the underground reservoir. Some systems comprise a plurality of pipes that are coupled end to end to form the pipe column extending through the borehole. The pipes and the pipe columns can vary in length, diameter, and material depending on the application, well configuration, and borehole depth.

A pipe for use in transporting fluid within a well can be delivered to a wellbore site and/or installed in the wellbore using heavy equipment, such as with masts on mobile vehicles or stationary masts. The mast can be outfitted with cables or other means configured to lift and orient the pipe over the well for insertion after which the pipe is lowered into place. However, the pipes can be heavy and cumbersome to maneuver into position. Accordingly, a need exists for improved systems for positioning pipes during well drilling and retrofitting operations, such as for example, for inserting pipes into wells.

### SUMMARY

Described herein is a system and a method for automated alignment of a pipe over a well for insertion into the well. In some examples, the alignment system described herein can be utilized with a stationary lifting structure like a mast for lifting a pipe element or pipe column. In some examples, the system can be used with a truck or other vehicle configured for lifting a pipe element or assembled pipe column.

The system and method described herein can be used for automated alignment of any pipe or pipe assembly relative to a well in any industry, such as for example, for oil, gas, or water operations. For example, the system and method described herein can be used for alignment of pipes or pipe columns/assemblies for lining a borehole (e.g., for installation of well casings). Additionally or alternatively, the system and method described herein can be used for alignment of pipes or pipe assemblies for insertion within pipes that are already installed within a borehole.

The alignment system can comprise a laser transmitter, a laser receiver, and a control unit configured to receive data indicative of a position of a laser beam from the laser transmitter projected onto the laser receiver. The position of the laser beam can indicate the axial position of the pipe relative to the well. The control unit can further be configured to transmit a command signal to adjust a tilt of a vehicle comprising a mast to which the pipe is coupled. By tilting the vehicle and with it the mast, the pipe can move laterally in relation to the well and into axial alignment therewith.

In some examples, the laser transmitter can be mounted to a first end portion of the mast and arranged to emit a downward or at least substantially downward-oriented laser beam onto the laser receiver situated below the laser transmitter, where the laser receiver is positioned adjacent the wellbore. The control unit can be used to evaluate the position of the laser beam on the laser receiver in relation to a target position and calculate a tilt of the vehicle that would result in movement of the laser beam closer to the target. Alternatively, in some examples, the position of the laser receiver and the laser transmitter can be swapped such that the laser receiver is mounted to the first end portion of the mast and the laser transmitter is situated adjacent the wellbore and below the laser receiver. In some examples, more than one laser transmitter and respective laser receiver can be used in the alignment system to aid in alignment of the pipe in relation to more than one axis.

In some examples, the mast can be fixedly attached to a vehicle that further comprises an outrigger or landing gear with an actuator, such as a hydraulic cylinder. In some examples, a separate displacement element with an actuator, such as a jack with a hydraulic cylinder, can be coupled to the outrigger to tilt the vehicle in lieu of or in addition to an outrigger. The control unit can be coupled to an actuator of the outrigger and/or the displacement element to command the actuators to extend and retract to tilt the vehicle. As described above, this vehicle tilt can displace the mast attached thereto and, in turn, laterally displace the pipe coupled to the mast into alignment with the wellbore.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a side view schematically showing a control system for pipe alignment comprising a controller, a laser transmitter, and a laser receiver, according to an example, where the control system is used with a vehicle comprising an outrigger and a mast for lifting a pipe over a well.

FIG. 2 is a side view schematically showing the control system, vehicle, pipe, and well of FIG. 1, where the outrigger is extended to tilt the vehicle such that the pipe is aligned with the well.

FIG. 3 is a side view schematically showing the control system, vehicle, pipe, and well of FIG. 1, according to an example, where the laser receiver is mounted to the mast on the vehicle and the laser transmitter is positioned adjacent the well.

FIG. 4A is a top view of a laser receiver schematically showing a laser beam in a first position on the laser receiver relative to a target, according to an example.

FIG. 4B is a top view of the laser receiver of FIG. 4A schematically showing the laser beam in a second position relative to the target.

FIG. 5 is a top view schematically showing a control system for pipe alignment comprising a controller, a laser transmitter, and a laser receiver, according to an example, where the control system is used with a vehicle comprising two outriggers and a mast for lifting a pipe over a well.

FIG. 6A is a top view schematically showing a control system for pipe alignment, according to an example, comprising a controller and a plurality of laser transmitters, each with a corresponding laser receiver.

FIG. 6B is a detail view showing the plurality of laser transmitters with laser beams and respective laser receivers of FIG. 6A.

FIG. 7A is a side view of FIG. 6B showing a first laser beam on a first laser receiver relative to a first target.

FIG. 7B is a rear view of FIG. 6B showing a second laser beam on a second laser receiver relative to a second target.

FIG. 8 is a schematic block diagram of a control system for controlling alignment of a pipe over a well, according to an example.

FIG. 9 is a process flow diagram illustrating a representative method of aligning a pipe over a well, according to an example.

FIG. 10 illustrates a computing environment in which the control system of FIG. 8 can operate, according to an example.

FIG. 11 is a side view of the control system for pipe alignment of FIG. 1, according to an example, where the control system is configured to extend and retract a displacement element coupled to an outrigger.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved. The scope of this disclosure includes any features disclosed herein combined with any other features disclosed herein, unless physically impossible.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other

methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In the description, certain terms may be used such as “forward,” “front,” “rear,” “back,” “up,” “down,” “upper,” “lower,” “horizontal,” “vertical,” “left,” “right,” “longitudinal,” “lateral,” and the like. These terms are used, where applicable, to provide some clarity of description when dealing with relative relationships. However, these terms are not intended to imply absolute relationships, positions, and/or orientations. For example, with respect to an object, an “upper” surface can become a “lower” surface by turning the object over. Nevertheless, it is still the same object.

Similar components in different embodiments are described in the specification and illustrated in the figures with similar reference numbers for improved understanding and readability. However, it should be understood that this numbering convention is merely for convenience and is not intended to limit and/or exclude any claim scope.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

As used herein, “e.g.” means “for example,” and “i.e.” means “that is.”

Where applicable, values and relationships modified by the term “substantially” mean ±10% of the stated value or relationship. The term “substantially parallel” means an angle of ±10° between an object and a reference. The term “substantially perpendicular” means an angle of 60° to 120° between an object and a reference.

### Disclosed Technology

As introduced above, pipes can be installed in wells to transport a fluid such as water or oil to and from the surface, from a reservoir, such as for example, an underground aquifer. After a borehole is drilled from the surface providing access to the reservoir, a pipe can be inserted into the borehole. Depending on the depth of the borehole, this pipe can comprise a large number of pipe segments that are coupled to each other to form a length sufficient to span the depth.

As pipes are cumulatively coupled to each other either within the borehole or above ground, the pipe column can increase in weight, necessitating the use of heavy equipment for lifting and lowering. In some examples, a stationary structure or rig comprising a mast can be used to hoist a pipe or pipe column into the air and into position over a well.

In some examples, a vehicle comprising a mast can be driven to a work or installation site for use in hoisting a pipe segment or pipe column over an opening of a well on the surface. In some examples, the vehicle can be a mobile drilling rig vehicle including a mast with a rotary head movable up and down along the mast. The mast can include any of a variety of additional machines including a clamp for holding a pipe string inserted in the wellbore, and/or a carousel for holding pipe sections to be added to the pipe string.

As used herein, the term “mast” includes support structures such as cranes, booms, masts, towers, and derricks for the drilling, construction, maintenance, and rehabilitation of wells or boreholes. The structures may carry or include any of a variety of additional equipment, for example, winches, drive elements, clamps, coupling devices, controllers, sensors, and cutters.

Typical vehicles with masts used for such hoisting operations can often have outriggers that are configured to stabilize and support the vehicle during lifting maneuvers. These outriggers can be mounted to any portion of the vehicle, such as the chassis, and can comprise means for engaging with and/or securing to the ground.

For example, an outrigger can comprise an actuator arranged to extend the outrigger into contact with the ground and retract the outrigger for storage or transport. In other words, an actuator can be retracted into a stowed state when the vehicle is being driven and extended into a deployed state when the vehicle is at rest and is being used for hoisting. The stowed state can include a configuration in which the outrigger does not touch the ground. Alternatively, the outrigger can be extended to touch and apply force on the ground in the deployed state. This engagement with the ground can provide additional stability and support to the vehicle during hoisting operations to reduce movement of the vehicle and prevent tipping under heavy loads. The degree of extension in the deployed state can vary depending on various factors. For instance, outriggers can also be utilized to level or steady a vehicle on uneven ground. That is, an outrigger can be extended by a prescribed amount to lift and tilt a vehicle into a level state.

In some examples, a vehicle can be equipped with two outriggers, one on each lateral side of the vehicle either at a front portion or a rear portion of the vehicle.

In some examples, a vehicle can be equipped with three outriggers or four or more outriggers, for example, two outriggers on each lateral side of the vehicle (e.g., four outriggers) with one each at a front portion and/or a rear portion of the vehicle.

In some examples, a vehicle can be equipped with any number of outriggers.

Actuators on an outrigger can take the form of a fluid cylinder, for example, comprising a fluid barrel and a ram or piston that displaces relative to the barrel when fluid is added and removed from the barrel. The displacement or throw of the piston can result in extension and retraction of the outrigger. The fluid cylinder can operate as part of a hydraulic system or a pneumatic system.

Although the examples of actuators described herein are directed primarily toward fluid cylinders, it is appreciated that any mechanical means can be used for outrigger movement. For example, the outrigger can comprise a component that extends or retracts due to rotation of a threaded element, an electric motor such as a voice coil motor, etc.

In some examples, deployment of an outrigger mounted on a vehicle can cause the vehicle to tilt or shift in position. For a vehicle comprising a mast lifting a work piece (for example, a pipe or a pipe column), this position shift or vehicle tilt can, in some instances, result in lateral movement of the suspended work piece in relation to the work site. Additionally (or alternatively), the coupling of added weight onto the work piece, for example by coupling an additional pipe to a suspended pipe column, can cause the vehicle to tilt or shift in position, resulting in lateral movement of the mast, and thus of the suspended work piece. This lateral movement can lead to misalignment between the suspended work piece and a target underneath the work piece. Misalignment can also occur when the vehicle or drilling rig supports the weight of a pipe string of well column pipe, such as when releasing an elevator plate. This can cause the working end of the vehicle to move or sag and change the position of the mast relative to the well.

In some cases, alignment between the suspended work piece and the target can be achieved through manual operator control of the vehicle, the outriggers, and/or separate displacement elements (e.g., jacks) positioned underneath the vehicle. That is, an operator can manually move the vehicle and/or extend or retract one or more of the outriggers and/or one or more displacement elements underneath one or more outriggers to align a suspended work piece with the target. This manual control, in some instances, can be imprecise and difficult to reliably and consistently achieve. As such, an automated control system and method for aligning a suspended work piece over a target at a work site, as introduced above, can be advantageous for improving the ease and reliability of alignment.

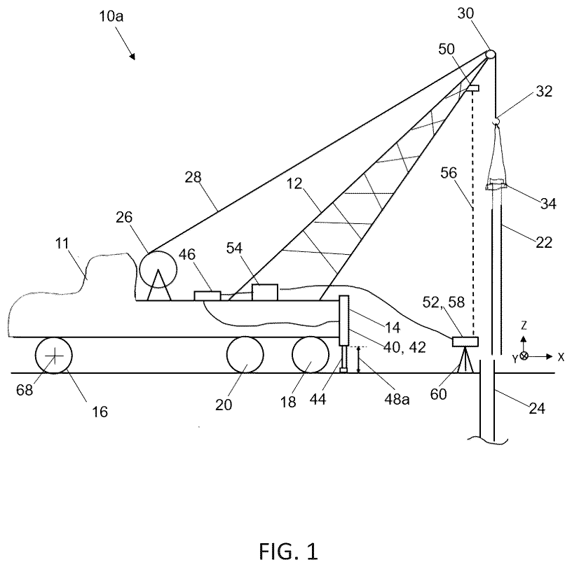

FIG. 1 schematically shows a work site system 10a for a wellbore that includes a vehicle 11 comprising a mast 12, an outrigger 14, a first pair of wheels 16 at a front portion of the vehicle, a second pair of wheels 18 at a rear portion of the vehicle, and optionally a third set of wheels 20 between the first and second pairs of wheels 16, 18. The mast 12 is configured to hoist a work piece, for example a pipe 22, over a target which is shown as a wellbore 24. The wellbore 24 can be utilized for the transfer of oil and gas or, for example, fresh water. Although the vehicle 11 in FIG. 1 is shown lifting a pipe over a well, it is understood that any work piece can be lifted using the same system and aligned with any target underneath. Referring to FIG. 1, the outrigger 14 is configured to extend into engagement with the ground, as shown in FIG. 1, for vehicle stability.

In some examples, the mast 12 can have a first end portion fixedly secured to the vehicle 11. That is, the mast 12 can be mounted to the vehicle 11 such that it cannot move in relation thereto. In other examples, as will be described in more detail below, a position of the mast 12 can be adjusted in relation to the vehicle 11.

The vehicle 11 can be outfitted with a winch 26 coupled to a first end of a cable 28. In some examples, the cable 28 can be wound around the winch 26 and arranged over a pulley 30 disposed at a second end portion of the mast 12. Disposed at a second end portion of the cable 28 is a hook or other coupling arrangement 32 to which an elevator 34 is connected. The elevator 34 is configured to couple to the pipe 22. To hoist the pipe 22, the winch 26 can be actuated to wind the cable 28 which pulls the cable 28 around the pulley 30. This winding action lifts the elevator 34 and, in turn, lifts the pipe 22 into the air as shown in FIG. 1. Although the coupling arrangement 32 is shown attached to the elevator 34, it is possible that the coupling arrangement 32 can be other attachment means attached directly to a portion of the pipe 22, another workpiece as described above, or an intermediate component (such as, for example, a spider or top drive element) which is coupled to a pipe or work piece.

The pipe 22 shown in FIGS. 1-3 and 11 can be, in some examples, a single pipe element. In other examples, the pipe 22 can be a pipe column comprising a plurality of coupled pipe elements. For the sake of simplicity, only one pipe element is illustrated.

The outrigger 14 can be configured with an actuator, such as for example, a fluid cylinder 40 comprising a fluid barrel 42 and a piston rod 44. In some examples, the fluid cylinder 40 can be a hydraulic cylinder or a pneumatic cylinder. As a volume of fluid in at least a portion of the barrel 42 increases, the piston rod 44 is pushed into an extended configuration. Conversely, as the volume of fluid in the portion of the barrel 42 decreases, the piston rod 44 can be retracted. The amount of fluid in portions of the barrel 42, and thus the movement of the rod 44, can be controlled by a control valve (such as, for example, a spool valve) 46 that is fluidly coupled to the barrel 42.

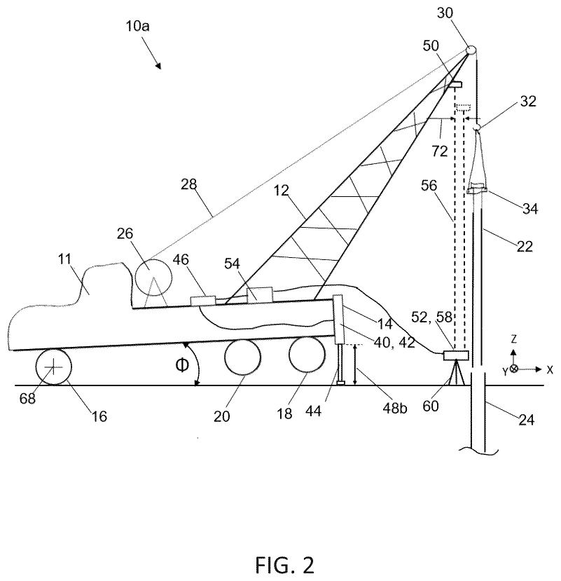

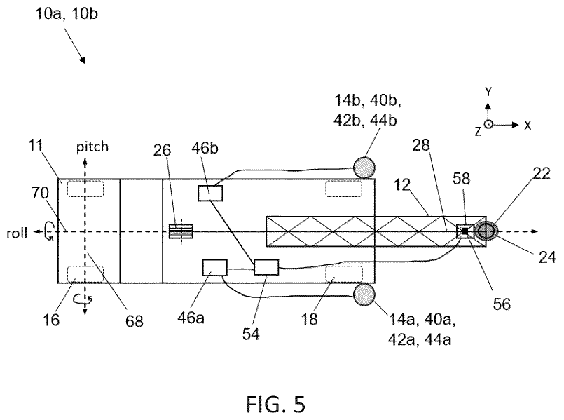

As shown schematically in FIG. 1, an end of the piston rod 44 is configured to extend a first distance 48a to engage the ground. Although the rod 44 is shown in FIG. 1 in direct engagement with the ground, it is understood that the rod 44 can be coupled to another component of the outrigger that directly engages the ground instead. In some instances, the piston rod 44 can be extended a distance greater than the first distance 48a to push against the ground and lift the rear portion of the vehicle 11, as will be described in more detail below in connection with FIG. 2. Although only one outrigger 14 is shown schematically in the side view of FIG. 1, it is appreciated that the vehicle 11 can have two outriggers 14 attached thereto as will be described below in connection with FIG. 5, or more than two outriggers 14, for example four outriggers 14.

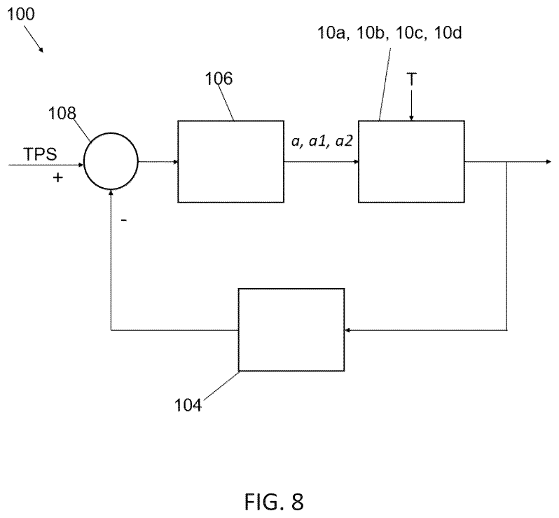

As described above, when the outrigger 14 is deployed to stabilize the vehicle 11, extension of the outrigger 14 can shift an angle or position of the mast 12 lifting the pipe 22. In some instances, the addition of suspended weight can also shift an angle or position of the mast 12. This shift can result in a misalignment of the pipe 22 over the well 24 as illustrated schematically in FIG. 1. To facilitate automated alignment of the pipe 22 over the well 24, a control system (for example, control system 100 in FIG. 8) can be implemented to automatically adjust movement of the piston rod 44 to tilt the vehicle 11.

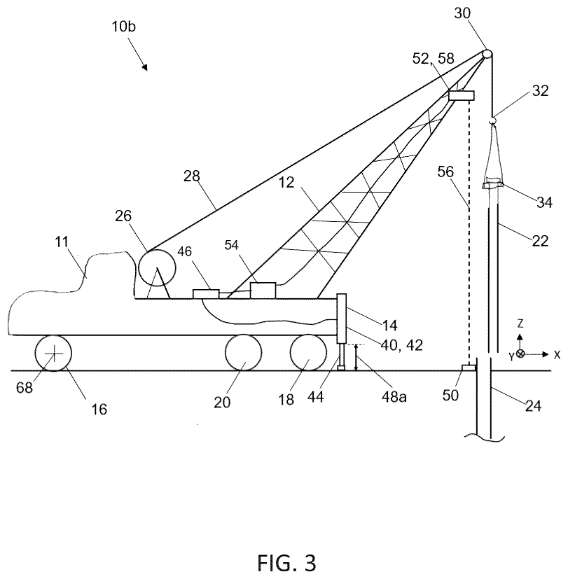

The work site system 10a can include a laser transmitter 50 mounted to the second end portion of the mast 12, a laser receiver 52 positioned adjacent the well 24, and a control unit (also referred to herein as a “controller”) 54 arranged to receive signals from the laser receiver 52. Although FIGS. 1-2 illustrate the laser receiver 52 adjacent the well 24 and the laser transmitter 50 mounted to the second end portion of the mast 12, it is understood that the positions of the laser receiver 52 and the laser transmitter 50 can be swapped, as shown in FIG. 3. In other words, as will be described in more detail below in connection with FIG. 3, the laser receiver 52 can be mounted to the second end portion of the mast 12 and the laser transmitter 50 can be positioned adjacent the well 24, as long as the laser transmitter 50 and the laser receiver 52 are oriented with respect to each other to cooperatively indicate relative movement therebetween. Additionally, although FIGS. 1-3 show the control unit 54 mounted to the vehicle 11 and with a wired connection to the laser receiver 52, it is understood that the control unit 54 can be mounted to any location on or off the vehicle 11 and can be wirelessly connected to the laser receiver 52 to receive data therefrom.

As shown in FIGS. 1-2, the laser transmitter 50 can be mounted on the mast 12 such that an emitted or projected laser beam 56 is directed toward the laser receiver 52. For example, the laser beam 56 can be directed downward toward the ground and onto the laser receiver 52. The laser receiver 52 can be accordingly positioned adjacent the well 24 such that it can receive the laser beam 56 thereon.

FIG. 3 schematically shows a work site system 10b for a wellbore, according to an example, with a similar arrangement as the work site system 10a shown in FIGS. 1-2, except for the positions of the laser receiver 52 and the laser transmitter 50 which are swapped with each other. That is, the laser receiver 52 is positioned on the distal end portion of the mast 12 and the laser transmitter 50 is positioned adjacent to the well 24 beneath the laser receiver 52 in FIG. 3. Although FIG. 3 shows the laser transmitter and receiver 50, 52 swapped, it is appreciated that the work site system 10b is otherwise the same as the work site system 10a. As such, the description of the work site system 10a and the control system thereof applies to the description for the work site system 10b and is incorporated herein accordingly. For example, the laser receiver 52 in the position shown in FIG. 3 can similarly receive the laser beam 56 projected thereon. As such, the position of laser beam 56 on the laser receiver 52 can be similarly used by the control system (for example, control system 100 in FIG. 8) to automatically adjust movement of the piston rod 44 to tilt the vehicle 11.

The laser transmitter 50 can be oriented such that the emitted laser beam 56 forms a selected angle relative to the laser receiver 52. In some examples, the laser beam 56 can be perpendicular to the laser receiver 52. In other words, the laser transmitter 50 can be oriented such that the laser beam 56 forms a 90° angle relative to the laser receiver 52. In some examples, the laser beam 56 can be substantially perpendicular to the laser receiver 52, thus forming an angle, for example, between 60° and 120° in relation to the laser receiver 52.

In some examples, as shown in FIGS. 1-2, the laser receiver 52 can be immediately adjacent a top opening of the well 24. In some examples, the laser receiver 52 can be disposed a distance, for example 10-15 feet, from the top opening of the well 24. In some examples, the laser receiver 52 can be positioned beneath the laser transmitter 50. The laser receiver 52 can be positioned any distance from the top opening of the well 24 or any target as long as it can communicate with the laser transmitter 50 as described above. In some examples, when the laser transmitter is positioned on the mast 12 and the laser receiver 52 is positioned adjacent the well 24 as shown in FIGS. 1-2, the laser transmitter 50 can be self-leveling such that, as the vehicle 11 is tilted and the mast 12 accordingly changes angle, the laser transmitter 50 continues to emit a downwardly pointed laser beam 56 directed at the receiver 52 (e.g., normal thereto).

In some examples, the laser receiver 52 can comprise a planar sensor array (also referred to herein as an “array” or “planar array”) 58. For examples in which the laser receiver 52 is positioned adjacent the well 24 as shown in FIGS. 1-2, the laser receiver 52 can be mounted to a base 60 that can be movably positioned on the ground. In some examples, the base 60 can be a tripod or other mounting structure that enables adjustment of the lateral position of the sensor array 58 (e.g., closer to or away from the well 24 in an X and/or Y axis as shown in FIGS. 1-2). In some examples, the base 60 can additionally be configured for angular adjustment of the array 58 relative to the ground and/or the laser beam 56. In some examples, the planar array 58 can be adjusted by the base 60 such that the array 58 is oriented at a selected angle relative to the ground and/or the laser beam 56. For example, the planar array 58 can be adjusted such that it is parallel or substantially parallel to the ground. In other words, the planar array 58 can be adjusted such that it forms no angle or a +/−10° angle relative to the ground. Additionally or alternatively, the planar array 58 can be adjusted such that it is perpendicular to the laser beam 56, thus forming a 90° angle relative to the laser beam 56. In some examples, the planar array 58 can be adjusted such that it is at least substantially perpendicular to the laser beam 56, for instance, disposed at an angle between 60°and 120°relative to laser beam 56.

In some examples, the control unit 54 can be configured to receive a signal from the laser receiver 52 and transmit a command to the valve 46 which, in turn, adjusts the throw or extension of the rod 44 on the outrigger 14.

To align the pipe 22 over the well 24, as introduced above, the vehicle can be rotated by the outrigger 14 about an axis (also referred to herein as a “pitch” axis) 68 of the vehicle 11 which is defined by an axle of the first pair of wheels 16, as shown in FIGS. 1-2. A roll axis 70 of the vehicle 11 can be defined along a longitudinal centerline of the vehicle 11, as shown in FIG. 5.

FIG. 2 schematically shows the vehicle 11 rotated about the axis 68 by the outrigger 14, where the rod 44 is configured to extend a second distance or length 48b that is, in the example shown, greater than the first distance 48a to lift the vehicle into the tilted configuration shown. Although, the second and third pairs of wheels 18, 20 are shown in FIG. 2 as lifted off the ground, it is appreciated that the vehicle 11 can be lifted in some instances with the second and/or third pairs of wheels 18, 20 remaining in contact with the ground.

When the vehicle is tilted as shown in FIG. 2, the mast 12 likewise moves and, with it, so does the laser transmitter 50. In the example illustrated in FIG. 2 in comparison to FIG. 1, the laser transmitter 50 is shown displaced in an upward, vertical direction along a Z axis (i.e., away from the ground) and in a lateral direction along the X axis toward the front of the vehicle by a distance or displacement 72. This displacement 72 is reflected in a lateral displacement of the laser beam 56 on the laser receiver 52 along the X axis. That is, the displacement 72 can be sensed by the planar array 58 of the laser receiver 52 which remains stationary with respect to the ground and the well while the vehicle 11 moves.

For examples in which the laser receiver 52 is positioned on the distal end portion of the mast 12 and the laser transmitter 50 is positioned adjacent to the well 24 as shown in FIG. 3, the laser receiver 52 moves with the mast 12 relative to the laser transmitter 50 which is stationary. The displacement of the laser receiver 52 in relation to the laser transmitter 50 similarly yields the displacement 72 sensed by the planar array 58.

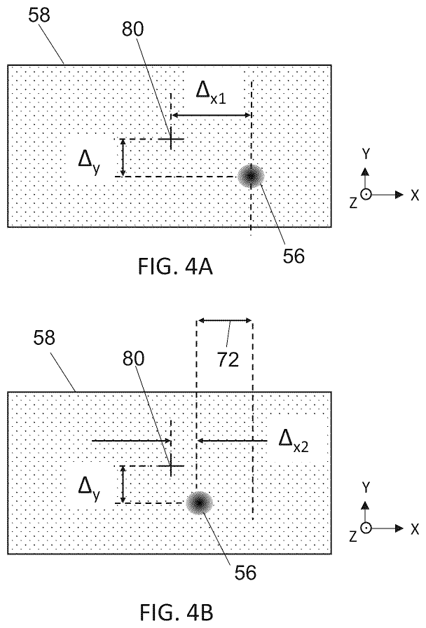

This displacement 72 is graphically represented in FIGS. 4A-4B which illustrate schematically a view of the planar array 58 of the laser receiver 52. More specifically, FIG. 4A illustrates a view of the planar array 58 before the vehicle 11 is tilted (as shown in FIGS. 1 and 3) and FIG. 4B shows the planar array 58 after the vehicle 11 is tilted (for example, as shown in FIG. 2). As shown in FIGS. 4A-4B, when the vehicle 11 is tilted the laser beam 56 moves along the X axis to the left by the displacement 72. In examples where the tilt of the vehicle is reduced (e.g., the length 48b is less than 48a), the laser beam 56 would move in an opposite direction relative to the laser receiver 52 along the X axis. That is, the laser beam 56 would move to the right.

A position of the laser beam 56 on the laser receiver 52 (e.g., on the array 58) can be, in some examples, compared to a target or target position 80 on the laser receiver 52 to gauge a relative error or offset, graphically shown in FIGS. 4A-4B as Δₓ and, in some examples described below, also as Δ_{y}. The target position 80 can be defined in some instances as the position of the laser beam 56 on the laser receiver 52 for which the pipe 22 is aligned or at least substantially aligned with the well 24. In some examples, the target position 80 can indicate a selected threshold representative of acceptable alignment. In this way, if the laser beam 56 is moved into alignment or substantial alignment (e.g., within 10%) with the target 80, the pipe 22 can be likewise moved into alignment or acceptable alignment with the well 24.

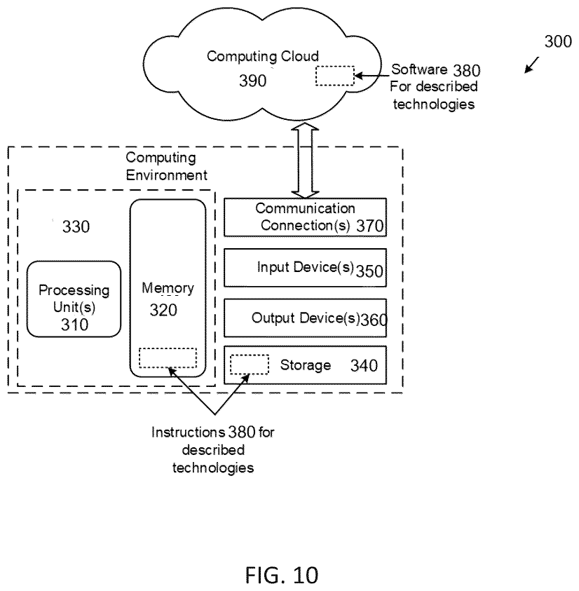

To achieve this alignment, a control system 100, according to an example as illustrated in the block diagram of FIG. 8, can be implemented to determine a position error of a laser beam on a respective laser receiver in relation to a target and accordingly adjust the tilt of the vehicle 11 until alignment or threshold alignment occurs. A work site system, for example, any work site system described herein such as 10a, 10b, 10c, 10d, is represented in the control system 100, as shown in FIG. 8. The control system 100 can further comprise an extrapolation element or block 104, an actuator control element or block 106, and a summing junction 108. In some examples, as will be described in more detail below in connection with FIG. 10, the control unit 54 can be configured, for example with a processor, to perform the steps represented by the extrapolation element 104, the actuator control element 106, and the summing junction 108.

With the application of an external trigger T, such as for example an operator engaged ON switch, a sensed coupling of a pipe, or a sensed deployment/extension of an outrigger, laser beam position data can be provided to the extrapolation element at block 104. This position data can be indicative of a position of a laser beam on a laser receiver (such as, for example, any laser beam described herein on a respective laser receiver or array) and can take various forms. For example, this position data can be converted by the extrapolation element 104 to determine a position of the laser beam on the laser receiver according to one or more axes (e.g., X, Y axes) to create a position signal.

The resulting position signal can be compared to (e.g., subtracted from as shown in FIG. 8) a target position signal TPS representative of a target (for example, any target described herein such as targets 80, 80ₓ, 80_{y}) at the summing junction 108. The target position signal TPS can vary depending on operator input and/or the position of the laser receiver relative to the well and the mast 12. In other words, the target specified on the receiver can move, for example, if the laser receiver is closer to or further from the well and/or the mast in any direction. In some examples, this target position signal TPS can be a selectable setting that is input by the operator.

Comparison (e.g., subtraction) of the position signal with the target position signal TPS can yield a position error signal representative of a displacement error in the X direction Δₓ₁ as shown graphically in FIG. 4A, and/or a displacement error in the Y direction Δ_{y}, the significance of which will be discussed further below. This position error signal can be provided to the actuator control element 106.

Using this position error signal, the actuator control element 106 can determine an actuation command a for transmission to the work site system 10a, 10b, 10c, 10d. In some examples, the actuator control element 106 can determine a calculated angle Φ of vehicle tilt that would reduce or eliminate the position error. Additionally, in the examples of outriggers comprising fluid cylinders, an extension of a fluid cylinder rod (such as, for example, rod 44) can be calculated. That is, the actuator control element 106 can calculate an extension distance of the fluid cylinder rod that would yield the calculated angle Φ to reduce or eliminate position error. In such examples, the actuation command a can be a command to a control valve (such as, for example, the control valve 46) or a fluid pump (such as, for example, fluid pump 402) to increase or decrease fluid to portions of a respective fluid barrel (e.g., any barrel described herein, such as the barrel 42 of the cylinder 40 of the outrigger 14). As described above, this change in fluid volume can result in a change in extension of the rod of an outrigger or a displacement element which could ultimately tilt the vehicle to the calculated angle Φ.

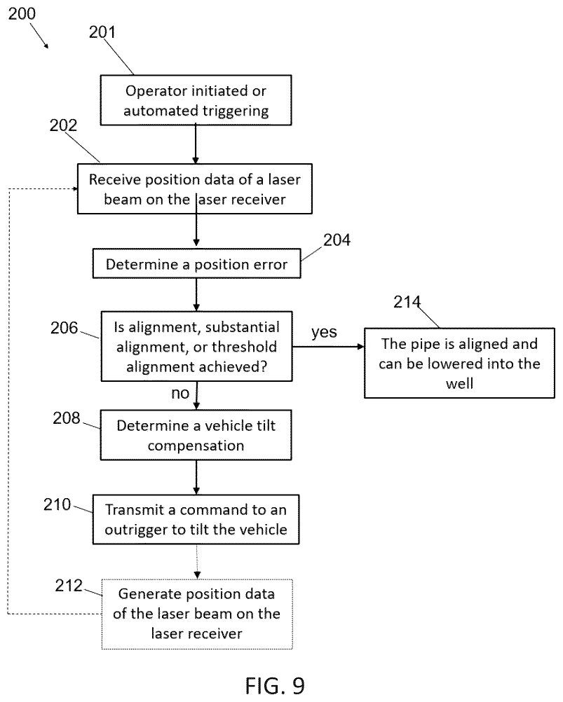

Referring to FIG. 4B, when the vehicle 11 is tilted, the laser beam 56 on the mast 12 is accordingly displaced as described above, yielding a new position of the laser beam 56 on the laser receiver 52. Per the control system 100 in FIG. 8, laser beam position data of the new position of the laser beam 56 can be provided to the extrapolation element at block 104 and a resulting position signal can be subtracted from the TPS at the summing junction 108 to yield an updated position error signal. This updated position error signal is representative of a new difference in the X direction Δₓ₂ shown graphically, for example, in FIG. 4B. The control system 100 continues until subtraction of the position signal from the target position signal TPS yields zero, substantially zero (for example, within 10% of the target), or a pre-selected error threshold. In other words, as shown in FIG. 9, the control system 100 can continue transmitting an actuation command until substantial alignment (e.g., within 10%) or threshold alignment has been achieved at which point a pipe (such as the pipe 22) can be lowered into a well.

FIG. 9 is a process flow diagram illustrating a representative method 200 of aligning a pipe over well using a control system, such as the control system 100, according to an example. The method begins with a trigger action at step 201, such as for example, an operator initiated action like engagement of a switch, a sensed coupling of a pipe, or a sensed deployment/extension of an outrigger. Laser beam position data can be received on a laser receiver in step 202 after which a position error is determined at step 204. At step 206, the control system ascertains if alignment or an alignment threshold is met. If not, the control system determines a vehicle tilt compensation at step 208 and transmits a command accordingly to an outrigger in step 210. Actuation of the outrigger leads to a change in position of the laser beam on the laser receiver which generates position data of the laser beam on the laser receiver in step 212. This new position data of the laser beam on the laser receiver is received at step 202 again and is subsequently evaluated in step 204 to determine a position error.

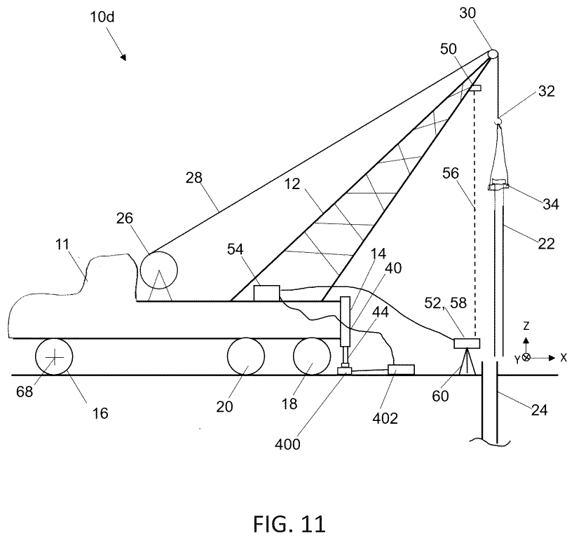

The process flow continues iteratively in a loop as shown in FIG. 9, each time determining a position error in step 204 and accordingly determining a vehicle tilt in step 208 and transmitting a tilt command in step 210 to tilt the vehicle. This iterative loop continues until the control system ascertains that alignment or an alignment threshold has been met at step 206 at which point the pipe can be lowered into the well at step 214. The control system then ceases adjustment of the outrigger until triggered again at step 201, for example, by an operator, sensed coupling of a pipe, or sensed movement of an outrigger relative to the vehicle. Although the description of the method 200 in FIG. 9 details actuation of an outrigger, it is appreciated that the method 200 can apply to any displacement element as will be described in more detail below in connection with FIG. 11.

FIG. 10 illustrates a generalized example of a computing environment 300 in which software and control algorithms for the described examples can be implemented. For example, software and/or hardware for implementing the various control systems and methods described herein (such as, for example, the control system 100) can be configured similarly to the computing environment 300 and can be a local computing system integrated as part of the control unit 54 or can be a remote computing system as described herein.

The computing environment 300 is not intended to suggest any limitation as to scope of use or functionality of the technology, as the technology may be implemented in diverse general-purpose or special-purpose computing environments. For example, the disclosed technology may be implemented with other computer system configurations, including programmable automation controllers, programmable logic controllers, application-specific integrated circuits (ASICs), field-programmable gate arrays (FPGAs), hand held devices, multi-processor systems, programmable consumer electronics, network PCs, minicomputers, and the like. The disclosed control methodology may also be practiced in distributed computing environments where tasks are performed by remote processing devices that are linked through a communications network. In a distributed computing environment, program modules may be located in both local and remote memory storage devices.

With reference to FIG. 10, the computing environment 300 includes at least one processing unit 310 and memory 320. In FIG. 10, this most basic configuration 330 is included within a dashed line. The processing unit 310 executes computer-executable instructions and may be a real or a virtual processor. In a multi-processing system, multiple processing units execute computer-executable instructions to increase processing power and as such, multiple processors can be running simultaneously. The memory 320 may be volatile memory (e.g., registers, cache, RAM), non-volatile memory (e.g., ROM, EEPROM, flash memory, etc.), or some combination of the two. The memory 320 stores software 380 that can, for example, implement the technologies described herein. A computing environment may have additional features. For example, the computing environment 300 includes storage 340, one or more input devices 350, one or more output devices 360, and one or more communication connections 370. An interconnection mechanism (not shown) such as a bus, a controller, or a network, interconnects the components of the computing environment 300. Typically, operating system software (not shown) provides an operating environment for other software executing in the computing environment 300, and coordinates activities of the components of the computing environment 300.

The storage 340 may be removable or non-removable, and includes non-volatile solid state memory, magnetic disks, or any other medium which can be used to store information and that can be accessed within the computing environment 300. The storage 340 stores instructions for the software 380, plugin data, and messages, which can be used to implement technologies described herein.

The input device(s) 350 may be, for example, an accelerometer, a position sensor such as an optical time-of-flight sensor, a temperature sensor, a position encoder, or a touch input device such as a switch, keyboard, keypad, mouse, touch screen display, pen, or trackball, a voice input device, a scanning device, or another device, that provides input to the computing environment 300. The output device(s) 360 may be a wired or wireless signal transmitter, a display, or another device that provides output from the computing environment 300.

The communication connection(s) 370 enable communication over a communication medium (e.g., a connecting network) to devices or computing entities. The communication medium conveys information such as control signals, computer-executable instructions, sensor inputs or outputs, or other data in a modulated data signal. The communication connection(s) 370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controlled devices.

Some examples of the disclosed methods can be performed using computer-executable instructions implementing all or a portion of the disclosed technology in a computing cloud 390 or other remote computing system. For example, the disclosed methods can be executed on processing units 310 located in the computing environment 330, or the disclosed methods can be executed on servers located in the computing cloud 390.

Computer-readable media are any available media that can be accessed within a computing environment 300. By way of example, and not limitation, with the computing environment 300, computer-readable media include memory 320 and/or storage 340. As should be readily understood, the term computer-readable storage media includes the media for data storage such as memory 320 and storage 340, and not transmission media such as modulated data signals.

In some examples, it can be advantageous to align a pipe with a well in more than one direction. For example, the pipe 22 can be aligned with the well 24 along both the X and Y axes (e.g., in a plane defined by the X and Y axes) as shown in FIGS. 4A-4B. As such, the control system 100, specifically the summing junction 108, can output a displacement error in the X direction Δₓ as well as a displacement error in the Y direction Δ_{y}, as introduced above. The actuator control element 106 can determine a calculated angle of vehicle tilt in two axes, such as a pitch (also referred to herein as a “first angle”) around the axis 68 and a roll (also referred to herein as a “second angle”) around the axis 70. In concert, this pitch and roll tilting can reduce or eliminate the position error.

FIG. 5 schematically shows the work site systems 10a, 10b for a wellbore, as viewed from above, comprising the vehicle 11 with the mast 12 as well as the laser receiver 52 and laser transmitter 50 as described above in connection with FIGS. 1-3. The work site systems 10a, 10b further comprise two outriggers 14a, 14b disposed on opposite sides of the vehicle 11 as shown in FIG. 5. Tilt angles around the pitch and roll axes 68, 70 can be achieved, for example, by adjusting rods 44a, 44b of the two outriggers 14a, 14b. Each outrigger 14a, 14b can be configured with a fluid cylinder 40a, 40b comprising a respective fluid barrel 42a, 42b and piston rod 44a, 44b. A fluid in each barrel 42a, 42b can be controlled by a respective control valve 46a, 46b. In this way, each outrigger 14a, 14b can be controlled independently of the other outrigger.

For example, a first actuation command a1 can be transmitted to the control valve 46a to increase or decrease fluid in portions of the barrel 42a of the outrigger 14a while a second actuation command a2 can be transmitted to the control valve 46b to increase or decrease fluid in portions of the barrel 42b of the other outrigger 14b. As described above, this change in fluid volume can result in a change in respective extension of the rods 44a, 44b which can tilt the vehicle to the calculated pitch and roll angles about respective axes 68, 70. In some examples, the outriggers 14a, 14b can be extended and/or retracted by different amounts. In some examples, the outriggers 14a, 14b can be extended and/or retracted by the same amount. This tilting can reduce or eliminate position error in the laser beam on the laser receiver for improved pipe alignment.

The description above and FIGS. 1-3, and 5 show one control valve 46 for each fluid cylinder 40 (and outrigger 14). However, it is understood that each fluid cylinder 40 (and outrigger 14) can be controlled by two control valves (such as, for example, spool valves) that act on different fluid volumes disposed on opposite sides of the piston rod 44. These opposing fluid volumes move the piston rod 44 in one direction or another. As such, the control valves can be accordingly controlled to increase and decrease opposing fluid volumes to raise and lower the outriggers.

Although the examples described herein are directed to vehicles comprising one or two outriggers, it is possible to arrange any number of outriggers (e.g., 1, 2, 3, 4, 5, 6) on the vehicle for positional control of the vehicle and thus movement of the mast and a work piece coupled thereto. In some examples, more outriggers can yield improved positional control for alignment. For example, a vehicle can be outfitted with four outriggers, two on either lateral side of the vehicle with one on each of a front and rear end portion of the vehicle (e.g., adjacent all four corners of the vehicle). Each outrigger mounted to the vehicle could, for example, be coupled to a controller (e.g., a control system) via its own, respective valve or valves for independent operation thereof. In this way, vehicle tilt can have nuanced control. It is also appreciated that any number of a total number of outriggers (e.g., one or two out of four outriggers) can be actuated to adjust tilt as needed. In other words, not all of the outriggers coupled to a vehicle need be actuated to adjust vehicle tilt.

In some examples, a pipe can be aligned with a well in more than one direction (e.g., along both the X and Y axes) using more than one laser transmitter and respective laser receiver. That is, instead of sensing displacement of a single laser beam on a single laser receiver relative to two directions, two decoupled laser systems each having a laser transmitter and a laser receiver can be used. In other words, displacements in each of two directions can be denoted by separate, decoupled laser beams on respective laser receivers. Decoupling error or displacement in the X and Y axes by using separate laser transmitters and receivers for each axis can, in some instances, facilitate repositioning of equipment in the field.

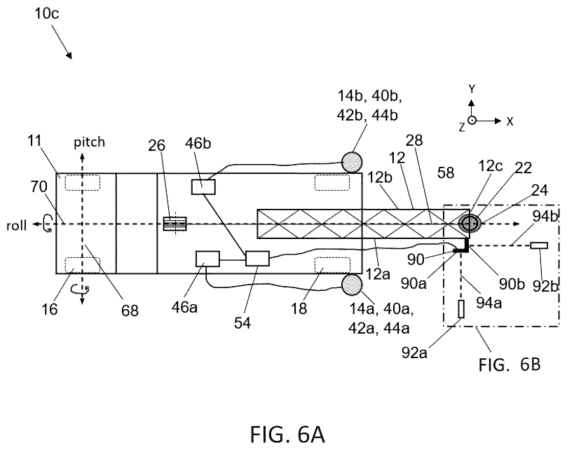

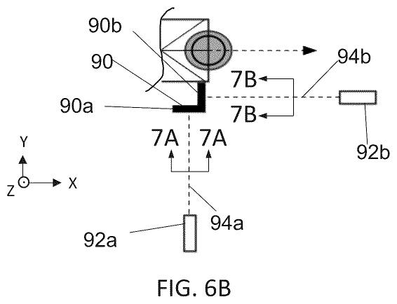

FIG. 6A schematically shows a work site system 10c for the wellbore 24, as viewed from above, comprising the vehicle 11 of FIG. 5 with two outriggers 14a, 14b and the mast 12 lifting the pipe 22 over the wellbore 24. The mast 12 can have a first lateral side 12a, a second lateral side 12b opposite the first lateral side 12a, and an end 12c facing a rearward direction of the vehicle 11 as shown in FIG. 6A. The work site system 10c can further include a laser receiver assembly 90 comprising a first laser receiver 90a and a second laser receiver 90b. Although the first and second laser receivers 90a, 90b are shown connected to each other to form the laser receiver assembly 90 in FIG. 6A, it is appreciated that the first and second laser receivers 90a, 90b can be separate components from each other. For example, the first laser receiver 90a can be positioned on the first or second lateral sides 12a, 12b of the mast 12 and arranged to extend along the X axis while the second laser receiver 90b can be a separate component that is positioned on the end 12c of the mast 12 and arranged to extend along the Y direction. The first and second receivers 90a, 90b can be oriented perpendicular or substantially perpendicular (e.g., within an angle of 60° to 120°) to each other. Additionally, the first and second receivers 90a, 90b can be positioned on the mast 12 such that they are not obstructed.

The work site system 10c can further comprise a first laser transmitter 92a and a second laser transmitter 92b both arranged in a position off-vehicle. For example, each of the first and second laser transmitters 92a, 92b can be arranged on the ground specified distances from the wellbore 24. Although the first and second receivers 90a, 90b are shown and described as mounted to the mast 12 and the first and second laser transmitters 92a, 92b are shown and described as disposed on the ground, their positions can be swapped. In other words, the first and second laser transmitters 92a, 92b can be mounted to the mast 12 and the first and second receivers 90a, 90b can be positioned off-vehicle adjacent the wellbore 24.

In some examples, the laser transmitters 92a and 92b can be configured to project laser beams in vertical and/or horizontal lines. The laser beams can thus be projected in two-dimensional planes that can extend up to 360°around the laser transmitters. As shown in FIG. 6B, the first laser transmitter 92a can be oriented such that a first emitted or projected laser beam 94a is directed toward the first laser receiver 90a. In some examples, the first laser beam 94a can be perpendicular to the first laser receiver 90a. In other words, the first laser transmitter 92a can be oriented such that the first the laser beam 94 a forms a 90° angle relative to the first laser receiver 90a. In some examples, the first laser beam 94a can be substantially perpendicular to the first laser receiver 90 a, thus forming an angle, for example, between 60° and 120° in relation to the first laser receiver 90a.

Similarly, the second laser transmitter 92b can be oriented such that a second emitted or projected laser beam 94b is directed toward the second laser receiver 90b. In some examples, the second laser beam 94b can be perpendicular to the second laser receiver 90b. In other words, the second laser transmitter 92 b can be oriented such that the second the laser beam 94 b forms a 90°angle relative to the second laser receiver 90b. In some examples, the second laser beam 94b can be substantially perpendicular to the second laser receiver 90b, thus forming an angle, for example, between 60° and 120° in relation to the second laser receiver 90b.

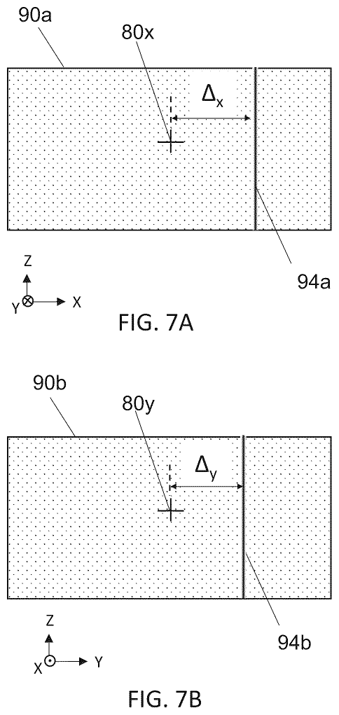

As shown in FIGS. 7A-7B, each of the two laser receivers indicates displacement or error in one direction (e.g., either along the X direction or the Y direction). FIG. 7A illustrates the first laser beam 94a on the first laser receiver 90a while FIG. 7B illustrates the second laser beam 94b on the second laser receiver 90b. The first and second laser receivers 90a, 90b are shown in FIGS. 7A-7B as planar receivers oriented toward their respective laser transmitters 92a, 92b. Both of the first and second laser beams 94a, 94b are depicted as vertically oriented laser lines on their respective first and second laser receivers 90a, 90b.

Referring to FIG. 7A, a position of the first laser beam 94a on the first laser receiver 90a can be, in some examples, compared to a target or target position 80ₓ on the first laser receiver 90a to gauge a relative error or offset in the X direction (e.g., vehicle fore to aft), graphically shown in FIG. 7A as Δₓ. That is, the first laser receiver 90a and first laser transmitter 92a can be used to denote error or offset in the X axis.

Conversely, a position of the second laser beam 94b on the second laser receiver 90b can be, in some examples, compared to a target or target position 80_{y} on the second laser receiver 90b to gauge a relative error or offset in the Y direction (e.g., vehicle left to right), graphically shown in FIG. 7B as Δ_{y}. That is, the second laser receiver 90b and second laser transmitter 92b can be used to denote error or offset in the Y axis. As described above in connection with FIGS. 4A-4B, the target positions 80ₓ, 80_{y} can be defined in some instances as the position of the first and second laser beams 94a, 94b on the first and second laser receivers 90a, 90b for which the pipe 22 is aligned or at least substantially aligned with the well 24 in the X-Y plane. In some examples, the target positions 80ₓ, 80_{y} can indicate a selected threshold representative of acceptable alignment. In this way, if the first and second laser beams 94a, 94b are moved into alignment or substantial alignment (e.g., within 10%) of their respective targets 80ₓ, 80_{y}, the pipe 22 can be likewise moved into alignment or acceptable alignment with the well 24.

As described above in connection with FIG. 8, the control system 100 can determine the position errors Δₓ, Δ_{y} on the first and second laser receivers 90a, 90b in relation to the targets 80ₓ, 80_{y} and accordingly adjust the tilt of the vehicle 11 until alignment or threshold alignment occurs per the method 200 detailed in connection with FIG. 9. In some cases, the outriggers 14a, 14b as shown in FIG. 6A can be extended or retracted at the same time per the error or offset in the X direction Δₓ while, in some instances, one or the other of the outriggers 14a, 14b as shown in FIG. 6A can be extended or retracted per the error or offset in the Y direction Δ_{y}.

Although the system described herein is directed toward the alignment of a pipe over a well for subsequent lowering, the system can also be used to adjust alignment of a pipe column already at least partially lowered within a well. For example, to lengthen a pipe column to span the depth of a borehole, pipe elements can be sequentially coupled to an existing pipe column within the well. Each progressive coupling of a pipe element to this pipe column can result in additional weight on a mast from which the pipe column is suspended. This added weight can pull the mast into a shifted position, as described above, in which the pipe column is offset and, in some instances, in contact with a side of the wellbore. In this way, the addition of subsequent pipe elements may necessitate tilting of a vehicle to which the mast is mounted for re-alignment of the pipe column in the well in the same manner as described above.

As introduced above, in some examples, a mast (such as, for example, the mast 12) can be movably mounted to a vehicle (such as, for example, the vehicle 11). In other words, instead of being attached to a vehicle at a fixed, pre-determined angled, an angle of the mast can be adjustable in relation to the vehicle. In some examples, the mast can be moved via mechanical means such as fluid cylinders (e.g., hydraulic or pneumatic), gears, or threaded elements. As such, a control system (such as, for example, the control system 100) can be configured with automated adjustment of mast angle relative to the vehicle to which it is mounted to achieve alignment in addition to vehicle angle in the manner described above. Adjustment of the mast with respect to the vehicle in conjunction with adjustment of vehicle angle can provide additional adjustment opportunities.

In some examples, a vehicle may be tilted using means other than outriggers, for example, using one or more displacement elements to adjust vehicle tilt for pipe alignment with any of the methods and systems described above. Using one or more displacement elements, such as jacks, that are separate from the vehicle can advantageously permit use of a pipe alignment system as described herein with any vehicle with or without outriggers. Separate displacement elements also enable shared use of a pipe alignment system among more than one vehicle. That is, a pipe alignment system comprising a separate displacement element can be decoupled from one vehicle with a mast and applied to another vehicle with a mast for pipe alignment therewith. In this way, a fleet of vehicles can share one or more alignment systems and the alignment systems can be kits that are transferable from vehicle to vehicle. Separate controllable jacks positionable beneath a vehicle's outriggers can also bypass the vehicle's hydraulics and control system and allow the system to be used with any vehicle without retrofitting.

FIG. 11 schematically shows a work site system 10d for a wellbore that includes the vehicle 11 comprising the mast 12 and outrigger 14 as described in any of the work site systems 10a, 10b, 10c. As such, the descriptions of the vehicle 11, mast 12, and outrigger 14 of the work site systems 10a, 10b, 10c also apply to the work site system 10d and are incorporated herein accordingly. Although the work site system 10d of FIG. 11 is shown with the laser transmitter 50 and the laser receiver 52 of FIG. 1, it is appreciated that any configuration of laser transmitters and laser receivers (e.g., the laser receivers and transmitters of work site systems 10a, 10b, 10c) and control unit 54 with control system 100 can be implemented in the work site system 10d in FIG. 11.

In contrast to the work site systems 10a, 10b, 10c, the work site system 10d comprises a separate displacement element in the form of a jack 400, for example, arranged underneath the outrigger 14. That is, in the example shown in FIG. 11, the jack 400 is positioned between the outrigger 14 and the ground. In some examples, the jack 400 can be coupled to a lower end of the outrigger 14. Although the jack 400 is shown and described herein as being arranged between the outrigger and the ground, it is understood that the jack 400 can be arranged between the ground and any portion of the vehicle 11, such as for example, an undercarriage, vehicle frame or chassis, etc. It is also appreciated that any conventional displacement element can be implemented, such as a pad or puck cylinder, to affect vehicle tilt as described herein.

In some examples, the jack 400 can comprise an actuator, such as for example, a fluid cylinder comprising a fluid barrel and a piston rod. In some examples, the fluid cylinder can be a hydraulic cylinder or a pneumatic cylinder. As a volume of fluid in at least a portion of the barrel increases, the piston rod is pushed into an extended configuration which can, for example, tilt the vehicle 11 in the same manner as an extended outrigger described above. Conversely, as the volume of fluid in the portion of the barrel decreases, the piston rod can be retracted which can lower a portion of the vehicle 11 on which the jack 400 acts toward the ground, reducing vehicle tilt.

The amount of fluid in portions of the barrel, and thus the movement of the rod, can be controlled by an independent fluid pump 402 (e.g., a hydraulic pump) that is fluidly coupled to the barrel of the jack 400. The fluid pump 402 can be in communication with the control module 54 in the same manner as the control valves 46, 46a, 46b described above. That is, the extension and retraction of the jack 400 can be controlled by the fluid pump 402 which is operated by the control system 100. In this way, the jack 400 behaves much like the outrigger 14, 14a, 14b to tilt the vehicle 11.

In some examples, the fluid pump 402 can be a stand-alone component arranged off-vehicle as shown in FIG. 11 and fluidly coupled to the jack 400. In some examples, the fluid pump 402 can be positioned where convenient for operation of the jack 400 and for communication with the control module 54. Although the fluid pump 402 is shown with a wired connection to the control module 54 in FIG. 11, the fluid pump 402 can have wireless communication with the control module 54 to receive signals therefrom.

Although only one jack 400 is shown schematically in the side view of FIG. 11, it is appreciated that any number of jacks 400 can be used, each with its own fluid pump 402 for independent control by the control module 54. In some examples, the work site system 10d can be configured with a jack 400 coupled to each outrigger 14. In some examples, the vehicle 11 can have 2, 3, 4, 5, 6 separate displacement elements attached thereto for tilting.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A system comprising: a laser receiver; a laser transmitter configured to emit a laser beam in a direction of the laser receiver, wherein one of the laser receiver and the laser transmitter is positionable adjacent a well and the other of the laser receiver and the laser transmitter is mounted to a first end portion of a mast extending from a vehicle and configured to lift a pipe; an actuator coupled to the vehicle and configured to tilt the vehicle; and a controller in communication with the actuator and the laser receiver and configured to control the actuator to tilt the vehicle based at least in part on a location of the laser beam on the laser receiver.

Example 2. The system of any example herein, particularly example 1, wherein the system comprises more than one laser receiver each having a respective laser transmitter.

Example 3. The system of any example herein, particularly example 1, wherein the actuator comprises a fluid cylinder within an outrigger coupled to the vehicle, and wherein the controller is configured to extend and retract the outrigger to tilt the vehicle.

Example 4. The system of any example herein, particularly example 3, wherein the fluid cylinder within the outrigger is fluidly coupled to a valve configured to vary a volume of fluid in at least a portion of the fluid cylinder within the outrigger in response to a signal from the controller.

Example 5. The system of any example herein, particularly example 1, wherein the actuator comprises a fluid cylinder within a jack positioned beneath an outrigger coupled to the vehicle, and wherein the controller is configured to extend and retract the jack to tilt the vehicle.

Example 6. The system of any example herein, particularly example 5, wherein the fluid cylinder within the jack is fluidly coupled to a valve configured to vary a volume of fluid in at least a portion of the fluid cylinder within the jack in response to a signal from the controller.

Example 7. The system of any example herein, particularly example 1, wherein, when the laser transmitter is mounted to the first end portion of the mast and the laser receiver is positionable adjacent the well, the laser transmitter is configured to emit the laser beam downward toward the ground regardless of the tilting of the vehicle.

Example 8. The system of any example herein, particularly example 1, wherein the system comprises a first actuator disposed on a first side of the vehicle and a second actuator disposed on a second side of the vehicle opposite the first side, and wherein the first and second actuators extend and retract to tilt the vehicle.

Example 9. The system of any example herein, particularly example 8, wherein the first and second actuators comprise respective first and second fluid cylinders and wherein the controller is in communication with: a first valve fluidly coupled to the first fluid cylinder of the first actuator; and a second valve fluidly coupled to the second fluid cylinder of the second actuator, wherein the first and second valves are each configured to vary a volume of fluid in at least a portion of their respective first and second fluid cylinders in response to a respective signal from the controller.

Example 10. The system of any example herein, particularly example 8, wherein the first and second actuators are arranged to tilt the vehicle relative to one or more vehicle axes.

Example 11. The system of any example herein, particularly example 1, wherein the laser receiver comprises a panel array that is perpendicular or substantially perpendicular to the laser beam.

Example 12. The system of any example herein, particularly example 1, wherein, when the laser transmitter is mounted to the first end portion of the mast and the laser receiver is positionable adjacent the well, the laser receiver comprises a base configured to rest on a surface adjacent the well, and wherein the base is further configured to be leveled relative to the surface or relative to the laser beam.

Example 13. A system for aligning a pipe for insertion into a well, the system comprising: a laser receiver; a laser transmitter configured to emit a laser beam in a direction of the laser receiver, wherein one of the laser receiver and the laser transmitter is positionable adjacent a well and the other of the laser receiver and the laser transmitter is mounted to a first end portion of a mast extending from a vehicle and configured to lift the pipe; an actuator coupled to the vehicle; and a control system configured to: receive laser beam position data from the laser receiver; determine a position error of the laser beam on the laser receiver relative to a target position on the laser receiver based at least in part on the laser beam position data; calculate a vehicle angle to reduce the position error; and transmit a control signal to the actuator to move the vehicle to the calculated vehicle angle.

Example 14. The system of any example herein, particularly example 13, further comprising a control valve fluidly coupled to a hydraulic cylinder within the actuator and operable to receive a control signal from the control system, wherein the control valve adjusts a volume of fluid in at least a portion of the hydraulic cylinder to move the vehicle to the calculated vehicle angle.

Example 15. The system of any example herein, particularly example 13, wherein the system comprises two or more actuators coupled to the vehicle, wherein each actuator of the two or more actuators comprises a hydraulic cylinder fluidly coupled to a respective control valve, and wherein each control valve receives a control signal from the control system.

Example 16. The system of any example herein, particularly example 15, wherein the control system is configured to calculate a first vehicle angle in relation to a first vehicle axis and a second vehicle angle in relation to a second vehicle axis, and wherein the actuators of the two or more actuators are arranged to cooperatively move the vehicle to at least the calculated first and second vehicle angles.

Example 17. The system of any example herein, particularly example 13, wherein the control system is configured to continuously determine a position error, calculate a vehicle angle, and transmit a control signal to the actuator to move the vehicle to the calculated vehicle angle in a loop until the position error is zero, at least substantially zero, or at a pre-selected threshold.

Example 18. The system of any example herein, particularly example 13, wherein the control system is configured to determine a position error each time the actuator is moved relative to the vehicle.

Example 19. A method comprising: emitting a laser beam from a laser transmitter; detecting a position of the laser beam on a laser receiver, wherein one of the laser receiver and the laser transmitter is positionable adjacent a well and the other of the laser receiver and the laser transmitter is mounted to a mast extending from a vehicle and configured to lift a pipe; determining a position error of the laser beam based on the position of the laser beam on the laser receiver and a target position on the laser receiver; and with one or more actuators mounted in relation to the vehicle, tilting the vehicle to reduce the position error between the laser beam and the target position on the laser receiver to align the pipe with the well.

Example 20. The method of any example herein, particularly example 19, further comprising moving the mast relative to the vehicle to reduce the position error between the laser beam and the target position on the laser receiver.

Example 21. The method of any example herein, particularly example 19, wherein the acts of detecting a position of the laser beam on the laser receiver, determining a position error of the laser beam, and tilting the vehicle are continuously triggered until the position error reaches zero or a pre-selected threshold.

Example 22. The method of any example herein, particularly example 19, wherein the act of determining a position error of the laser beam is triggered each time an actuator is moved.

Example 23. The method of any example herein, particularly example 19, wherein the one or more actuators comprises fluid cylinders within outriggers coupled to the vehicle.

Example 24. The method of any example herein, particularly example 19, wherein the one or more actuators comprises fluid cylinders within jacks positioned beneath the vehicle.

The features described herein with regard to any example can be combined with other features described in any one or more of the other examples, unless otherwise stated. For example, any one or more of the features of one system for aligning a pipe can be combined with any one or more features of another system for aligning a pipe. As another example, any one or more steps of one method for aligning a pipe can be combined with any one or more steps of another method for aligning a pipe.

In view of the many possible examples to which the principles of the disclosed technology may be applied, it should be recognized that the illustrated embodiments are only examples and should not be taken as limiting the scope of the disclosure. Rather, the scope of the disclosure is at least as broad as the following claims and equivalents of the recited features. We therefore claim all that comes within the scope and spirit of these claims.

1. A system comprising:
a laser receiver;
a laser transmitter configured to emit a laser beam in a direction of the laser receiver, wherein one of the laser receiver and the laser transmitter is positionable adjacent a well and the other of the laser receiver and the laser transmitter is mounted to a first end portion of a mast extending from a vehicle and configured to lift a pipe;
an actuator coupled to the vehicle and configured to tilt the vehicle; and
a controller in communication with the actuator and the laser receiver and configured to control the actuator to tilt the vehicle based at least in part on a location of the laser beam on the laser receiver.

2. The system of claim 1, wherein the system comprises more than one laser receiver each having a respective laser transmitter.

3. The system of claim 1, wherein the actuator comprises a fluid cylinder within an outrigger coupled to the vehicle, and wherein the controller is configured to extend and retract the outrigger to tilt the vehicle.

4. The system of claim 3, wherein the fluid cylinder within the outrigger is fluidly coupled to a valve configured to vary a volume of fluid in at least a portion of the fluid cylinder within the outrigger in response to a signal from the controller.

5. The system of claim 1, wherein the actuator comprises a fluid cylinder within a jack positioned beneath an outrigger coupled to the vehicle, and wherein the controller is configured to extend and retract the jack to tilt the vehicle.

6. The system of claim 5, wherein the fluid cylinder within the jack is fluidly coupled to a valve configured to vary a volume of fluid in the fluid cylinder within the jack in response to a signal from the controller.

7. The system of claim 1, wherein, when the laser transmitter is mounted to the first end portion of the mast and the laser receiver is positionable adjacent the well, the laser transmitter is configured to emit the laser beam downward toward the ground regardless of the tilting of the vehicle.

8. The system of claim 1, wherein the system comprises a first actuator disposed on a first side of the vehicle and a second actuator disposed on a second side of the vehicle opposite the first side, and wherein the first and second actuators extend and retract to tilt the vehicle.

9. The system of claim 8, wherein the first and second actuators comprise respective first and second fluid cylinders and wherein the controller is in communication with:
a first valve fluidly coupled to the first fluid cylinder of the first actuator; and
a second valve fluidly coupled to the second fluid cylinder of the second actuator,
wherein the first and second valves are each configured to vary a volume of fluid in at least a portion of their respective first and second fluid cylinders in response to a respective signal from the controller.

10. The system of claim 8, wherein the first and second actuators are arranged to tilt the vehicle relative to one or more vehicle axes.

11. The system of claim 1, wherein, when the laser transmitter is mounted to the first end portion of the mast and the laser receiver is positionable adjacent the well, the laser receiver comprises a base configured to rest on a surface adjacent the well, and wherein the base is further configured to be leveled relative to the surface or relative to the laser beam.

12. A system for aligning a pipe for insertion into a well, the system comprising:
a laser receiver;
a laser transmitter configured to emit a laser beam in a direction of the laser receiver, wherein one of the laser receiver and the laser transmitter is positionable adjacent a well and the other of the laser receiver and the laser transmitter is mounted to a first end portion of a mast extending from a vehicle and configured to lift the pipe;
an actuator coupled to the vehicle; and
a control system configured to:
receive laser beam position data from the laser receiver;
determine a position error of the laser beam on the laser receiver relative to a target position on the laser receiver based at least in part on the laser beam position data;
calculate a vehicle angle to reduce the position error; and
transmit a control signal to the actuator to move the vehicle to the calculated vehicle angle.

13. The system of claim 12, further comprising a control valve fluidly coupled to a hydraulic cylinder within the actuator and operable to receive a control signal from the control system, wherein the control valve adjusts a volume of fluid in at least a portion of the hydraulic cylinder to move the vehicle to the calculated vehicle angle.

14. The system of claim 12, wherein the system comprises two or more actuators coupled to the vehicle, wherein each actuator of the two or more actuators comprises a hydraulic cylinder fluidly coupled to a respective control valve, and wherein each control valve receives a control signal from the control system.

15. The system of claim 14, wherein the control system is configured to calculate a first vehicle angle in relation to a first vehicle axis and a second vehicle angle in relation to a second vehicle axis, and wherein the actuators of the two or more actuators are arranged to cooperatively move the vehicle to at least the calculated first and second vehicle angles.

16. The system of claim 12, wherein the control system is configured to determine a position error, calculate a vehicle angle, and transmit a control signal to the actuator to move the vehicle to the calculated vehicle angle in a loop until the position error is zero, at least substantially zero, or at a pre-selected threshold.

17. A method comprising:
emitting a laser beam from a laser transmitter;
detecting a position of the laser beam on a laser receiver, wherein one of the laser receiver and the laser transmitter is positionable adjacent a well and the other of the laser receiver and the laser transmitter is mounted to a mast extending from a vehicle and configured to lift a pipe;
determining a position error of the laser beam based on the position of the laser beam on the laser receiver and a target position on the laser receiver; and
with one or more actuators mounted in relation to the vehicle, tilting the vehicle to reduce the position error between the laser beam and the target position on the laser receiver to align the pipe with the well.

18. The method of claim 17, further comprising moving the mast relative to the vehicle to reduce the position error between the laser beam and the target position on the laser receiver.

19. The method of claim 17, wherein the acts of detecting a position of the laser beam on the laser receiver, determining a position error of the laser beam, and tilting the vehicle are repeated until the position error reaches zero or a pre-selected threshold.

20. The method of claim 17, further comprising determining a position error of the laser beam each time an actuator is moved.
